(19) United States
(12) Patent Application Publication
(10) Pub. No.: US 2005/0010920 A1
(43) Pub. Date: Jan. 13, 2005

(54) Storage media controller driver auto installing method and system

(76) Inventors: Wen-Hua Lin, Taipei (TW); Chen-Pin Lee, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/618,930

(22) Filed: Jul. 11, 2003

(51) Int. Cl. G06F 9/44

(52) U.S. Cl. 717/176; 717/174; 717/171

(57) ABSTRACT

A storage media controller driver auto installing method and system is proposed, which is designed for use with a computer platform, such as a network server, that is equipped with a storage media controller, such as an IDE (Integrated Device Electronics) or SCSI (Small Computer System Interface) compliant RAID (Redundant Array of Independent Disks) controller, for the purpose of installing a software-based driver for the RAID controller in a fully-automatic manner during the installation of an operating system, such as UNIX or WINDOWS, onto the server. This feature allows the driver installation process to be fully automatically carried out by the operating system, without requiring the network system management personnel to manually swap disks and manually input required settings for the installation of the driver, so that the driver installation process can be made more efficiently, effortlessly, and reliably.

### BACKGROUND OF THE INVENTION

1. Field of the Invention

This invention relates to information technology, and more particularly, to a storage media controller driver auto installing method and system which is designed for use with a computer platform, such as a network server, that is equipped with a storage media controller, such as an IDE (Integrated Device Electronics) or SCSI (Small Computer System Interface) compliant RAID (Redundant Array of Independent Disks) controller, for the purpose of installing a software-based driver for the RAID controller in a fully-automatic manner during the installation of an operating system, such as UNIX or WINDOWS, onto the server.

2. Description of Related Art

A network server is commonly equipped with a mass storage unit, such as a RAID (Redundant Array of Independent Disks) unit, to offer a very large data storage capacity. A RAID unit is typically controlled by IDE (Integrated Device Electronics) or SCSI (Small Computer System Interface) compliant controllers to allow the server to gain access to the RAID unit.

Different types of RAID controllers are typically operated through different types of drivers. Therefore, in order to allow a server to operate with a RAID controller, it is required to install a type-specific driver for the RAID controller after an operating system, such as UNIX or WINDOWS (NT/2000/XP/Server), has been installed to the server. For example, if a server is equipped with an IDE-compliant RAID controller, it is then required to install an IDE-specific driver onto the server for the server to be capable of operating with RAID controller; and if the server is equipped with an SCSI-compliant RAID controller, it is then required to install a SCSI-specific driver onto the server.

Traditionally, the installation of a software-based driver for a RAID controller is carried out manually step-by-step by the network system management personnel following on-screen instructions displayed on the monitor during the installation process. One drawback to this practice, however, is that it often requires the network system management personnel to manually swap disks for the installation of the driver, which is undoubtedly quite laborious and timing-consuming. Moreover, since manual installation requires the personnel to specify some hardware or system settings to let the drive coordinate with operating system and hardware, it is quite often that incorrect settings might be inputted or the personnel is confused about what are the correct settings to input. These drawbacks would undoubtedly make the installation process quite laborious and time-consuming and therefore is quite inefficient to the network management.

### SUMMARY OF THE INVENTION

It is therefore an objective of this invention to provide a storage media controller driver auto installing method and system that is capable of auto installing the required driver for a RAID controller equipped to a server without requiring the network system management personnel to manually swap disks for the installation of the driver so that the driver installation process can be carried out effortlessly and more quickly.

It is another objective of this invention to provide a storage media controller driver auto installing method and system that allows the driver installation process to be carried out in a fully-automatic manner without requiring the network system management personnel to manually input required settings, so that the driver installation process can be more reliably and efficiently.

The storage media controller driver auto installing method and system according to the invention is designed for use with a computer platform equipped with a certain type of storage media controller for the purpose of auto installing a software-based driver for the storage media controller during installation of an operating system onto the computer platform, and which is characterized by the methods of (1) checking which type of storage media controller is currently being equipped to the computer platform; (2) linking to a driver database which prestores a collection of an assortment of software-based drivers for a selected group of various types of storage media controllers; (3) retrieving a corresponding driver from the driver database that is mapped to the particular type of the storage media controller; and (4) loading the retrieved driver from the driver database onto the computer platform, allowing the computer platform to be capable of operating with the storage media controller. The storage media controller driver auto installing method and system according to the invention allows the driver installation process to be fully automatically carried out by the operating system, without requiring the network system management personnel to manually swap disks and manually input required settings for the installation of the driver, so that the driver installation process can be made more efficiently, effortlessly, and reliably.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an object-oriented component model of the storage media controller driver auto installing system according to the invention; and

FIG. 2 is a flow diagram showing the operational steps performed by the storage media controller driver auto installing method and system according to the invention.

### DETAILED DESCRIPTION OF PREFERRED EMBODIMENTS

The storage media controller driver auto installing method and system according to the invention is disclosed in full details by way of preferred embodiments in the following with reference to the accompanying drawings.

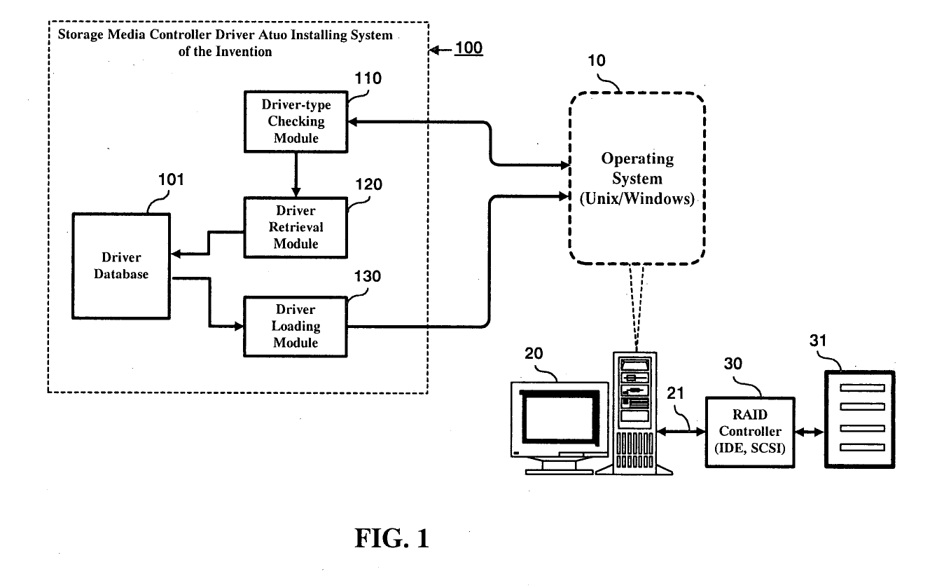

FIG. 1 is a schematic diagram showing the object-oriented component model of the storage media controller driver auto installing system (as the part enclosed in the dotted box indicated by the reference numeral 100). As shown, in application, the storage media controller driver auto installing system of the invention 100 is integrated to an operating system 10, such as UNIX or WINDOWS (NT/2000/XP/Server), which is to be installed onto a computer platform, such as a network server 20, that is equipped with a storage media controller, such as a RAID controller 30, used to control the operation of a data storage unit, such as a RAID (Redundant Array of Independent Disks) unit, which can be either IDE or SCSI compliant. The storage media controller driver auto installing system of the invention 100 is capable of installing a software-based driver for the RAID controller 30 during the installation of the operating system 10 onto the server 20, for the purpose of allowing the server 20 to operate with the RAID controller 30 to gain access to the RAID unit 31.

In practice, the storage media controller driver auto installing system of the invention 100 can be fully implemented via software and integrated as an add-on to the operating system 10. The object-oriented component model of the storage media controller driver auto installing system of the invention 100 comprises the following components: (a) a driver database 101; (b) a controller-type checking module 110; (c) a driver retrieval module 120; and (d) a driver loading module 130.

The driver database 101 is a data-only module, which is used to prestore a collection of an assortment of software-based drivers for a selected group of various types of storage media controllers, including, for example, a driver for IDE-compliant RAID controller, a driver for SCSI-compliant RAID controller, to name just a few.

The controller-type checking module 110 is capable of checking which type of storage media controller is the RAID controller 30 currently being equipped to the server 20. Since IDE and SCSI compliant RAID controllers are typically based on the well-known PCI (Peripheral Component Interconnect) bus architecture, the controller-type checking module 110 can gain access via a PCI bus 21 in the server 20 to a set of factory-built data that are embedded in the RAID controller 30, such as product serial number and manufacturer's ID, and can be used to identify the type of the RAID controller 30 currently equipped to the server 20.

The driver retrieval module 120 is capable of retrieving a corresponding software-based driver from the driver database 101 that is mapped to the particular type of the RAID controller 30 currently being equipped to the server 20.

The driver loading module 130 is capable of loading the retrieved driver from the driver database 101 by the driver retrieval module 120 onto to a specific folder in the file system of the operating system 10 installed to the server 20.

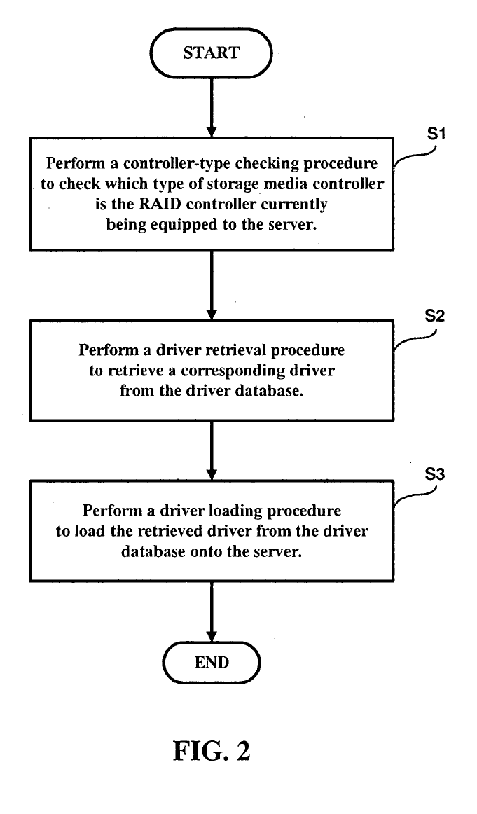

FIG. 2 is a flow diagram showing the operational steps performed by the storage media controller driver auto installing system of the invention 100 during the installation of the operating system 10 onto the server 20.

Referring to FIG. 2 together with FIG. 1, the first step S1 is to perform a controller-type checking procedure, wherein the controller-type checking module 110 is activated to check which type of storage media controller is the RAID controller 30 currently being equipped to the server 20. To do this, the controller-type checking module 110 can gain access via the PCI bus 21 in the server 20 to a set of factory-built data embedded in the RAID controller 30, such as product serial number and manufacturer's ID, which can be used to identify the type of the RAID controller 30 currently equipped to the server 20. The type information is then used as a keyword for database search in the next step S2.

The next step S2 is to perform a driver retrieval procedure, wherein the driver retrieval module 120 is activated to search through the driver database 101 using the type information provided by the controller-type checking module 110 as keyword to retrieve a corresponding driver for the RAID controller 30.

The next step S3 is to perform a driver loading procedure, wherein the driver loading module 130 is activated to load the retrieved driver from the driver database 101 by the driver retrieval module 120 onto to a specific folder in the file system of the operating system 10 installed to the server 20. This completes the installation of a driver for the RAID controller 30 by the storage media controller driver auto installing system of the invention 100.

When the operating system 10 is started, it will execute the driver to thereby allow the server 20 to be capable of operating with the RAID controller 30 to gain access to the RAID unit 31.

In conclusion, the invention provides a storage media controller driver auto installing method and system, which is designed for use with a computer platform, such as a network server, that is equipped with a certain type of storage media controller, such as RAID controller, for the purpose of auto installing a software-based driver for the storage media controller during installation of an operating system onto the computer platform, and which features that the driver installation process can be fully automatically carried out by the operating system, without requiring the network system management personnel to manually swap disks and manually input required settings for the installation of the driver, so that the driver installation process can be made more efficiently, effortlessly, and reliably. The invention is therefore more advantageous to use than prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A storage media controller driver auto installing method for use on a computer platform equipped with a certain type of storage media controller for the purpose of auto installing a software-based driver for the storage media controller during installation of an operating system onto the computer platform;
the storage media controller driver auto installing method comprising:
checking which type of storage media controller is currently being equipped to the computer platform;
linking to a driver database which prestores a collection of an assortment of software-based drivers for a selected group of various types of storage media controllers;
retrieving a corresponding driver from the driver database that is mapped to the particular type of the storage media controller; and
loading the retrieved driver from the driver database onto the computer platform, allowing the computer platform to be capable of operating with the storage media controller.

2. The storage media controller driver auto installing method of claim 1, wherein the operating system is a UNIX operating system.

3. The storage media controller driver auto installing method of claim 1, wherein the operating system is a WINDOWS operating system.

4. The storage media controller driver auto installing method of claim 1, wherein the storage media controller is an IDE-compliant RAID controller.

5. The storage media controller driver auto installing method of claim 1, wherein the storage media controller is a SCSI-compliant RAID controller.

6. A storage media controller driver auto installing system for use with a computer platform equipped with a certain type of storage media controller for the purpose of auto installing a software-based driver for the storage media controller during installation of an operating system onto the computer platform;
the storage media controller driver auto installing system comprising:
a driver database, which prestores a collection of an assortment of software-based drivers for a selected group of various types of storage media controllers;
a controller-type checking module, which is capable of checking which type of storage media controller is currently being equipped to the computer platform;
a driver retrieval module, which is capable of retrieving a corresponding driver from the driver database that is mapped to the particular type of the storage media controller; and
a driver loading module, which is capable of loading the retrieved driver from the driver database onto the computer platform, allowing the computer platform to be capable of operating with the storage media controller.

7. The storage media controller driver auto installing system of claim 6, wherein the operating system is a UNIX operating system.

8. The storage media controller driver auto installing system of claim 6, wherein the operating system is a WINDOWS operating system.

9. The storage media controller driver auto installing system of claim 6, wherein the storage media controller is an IDE-compliant RAID controller.

10. The storage media controller driver auto installing system of claim 6, wherein the storage media controller is a SCSI-compliant RAID controller.

11. A storage media controller driver auto installing system for use with a network server equipped with a certain type of RAID controller for the purpose of auto installing a software-based driver for the RAID controller during installation of an operating system onto the network server;
the storage media controller driver auto installing system comprising:
a driver database, which prestores a collection of an assortment of software-based drivers for a selected group of various types of RAID controllers;
a controller-type checking module, which is capable of checking which type of RAID controller is currently being equipped to the network server;
a driver retrieval module, which is capable of retrieving a corresponding driver from the driver database that is mapped to the particular type of the RAID controller; and
a driver loading module, which is capable of loading the retrieved driver from the driver database onto the network server, allowing the network server to be capable of operating with the RAID controller.

12. The storage media controller driver auto installing system of claim 11, wherein the operating system is a UNIX operating system.

13. The storage media controller driver auto installing system of claim 11, wherein the operating system is a WINDOWS operating system.

14. The storage media controller driver auto installing system of claim 11, wherein the RAID controller is an IDE-compliant RAID controller.

15. The storage media controller driver auto installing system of claim 11, wherein the RAID controller is a SCSI-compliant RAID controller.
